(19) United States
(12) Patent Application Publication
(10) Pub. No.: US 2026/0250083 A1
(43) Pub. Date: Aug. 27, 2026

(54) UNLOADING SYSTEM FOR AUTOMATICALLY UNLOADING AN OBJECT

(71) Applicant: ABB Schweiz AG, Baden (CH)

(72) Inventors: Tom Blondeel, Halle (BE); Willem Vanderhoydonk, Halle (BE)

(73) Assignee: ABB Schweiz AG, Baden (CH)

(21) Appl. No.: 19/648,821

(22) Filed: Apr. 15, 2026

Related U.S. Application Data
(63) Continuation of application No. PCT/EP2023/078866, filed on Oct. 17, 2023.

(51) Int. Cl. B65G 65/00; B65G 61/00

(52) U.S. Cl. CPC B65G 65/005; B65G 61/00; B65G 2201/025

(57) ABSTRACT

An unloading system for automatically unloading an object includes a robot arm having a gripper and a control unit. The control unit is configured to drive the robot arm to place the gripper at a side surface of the object and to allow the gripper to exert a lateral force to the object to drive the object to slide onto a loading surface.

### CROSS-REFERENCE TO RELATED APPLICATIONS

The instant application claims priority to International Patent Application No. PCT/EP2023/078866, filed Oct. 17, 2023, which is incorporated herein in its entirety by reference.

### FIELD OF THE DISCLOSURE

The present disclosure generally relates to an industrial process automation and, more particularly, to a system and method for automatically unloading an object.

### BACKGROUND OF THE INVENTION

Industrial automation systems may provide productive and cost-efficient solutions for various applications for modern continuous, batch and discrete processes. Among them, automatic unloading, including bulk unloading and item by item unloading, of containers and trucks is of great relevance in the field of logistics automation. One of the supply chain bottlenecks in the industrial automation process may be that the automatic unloading process of the containers has not been fully tackled yet. Using a conventional setup of robot grasping, an object or an item inside a container or a truck may be lifted or carried from the top or the side when picking them with a robot and then put on a conveyor. This lifting mechanism may be restricted for the implementation due to the limited space above the item to be picked and the design, the weight and the material of the individual item.

### BRIEF SUMMARY OF THE INVENTION

The present disclosure relates to industrial process automation. In particular, the present disclosure relates to an unloading system for automatically unloading an object, a robot arm for an unloading system, a loading plate for an unloading system, the use of an unloading system for automatically unloading an object from a container or a container of a truck, a method for automatically unloading an object, a computer program, a non-transitory machine readable data carrier and/or a download product with the computer program, and one or more computers and/or compute instances with the computer program and/or with the machine-readable data carrier and/or download product.

The present disclosure describes an optimized robotic container unloading system with a higher flexibility and automation efficiency.

According to a first aspect, an unloading system is provided for automatically unloading an object. The unloading system comprises a robot arm, which comprises a gripper, and a control unit. The control unit is configured to drive the robot arm to place the gripper at the object. Further, the control unit is configured to allow the gripper to exert a lateral force to the object and drive the object to slide onto a loading surface.

### BRIEF DESCRIPTION OF THE SEVERAL VIEWS OF THE DRAWING(S)

FIG. 1 is a schematic, partial outline view of an unloading system according to the present disclosure.

FIG. 2 is a schematic, partial outline of an unloading system comprising a control module according to the present disclosure.

FIG. 3 is a block diagram of a component construction of an unloading system according to the present disclosure.

FIG. 4 is a flowchart of a method for automatically unloading an object using an unloading system according to the present disclosure.

### DETAILED DESCRIPTION OF THE INVENTION

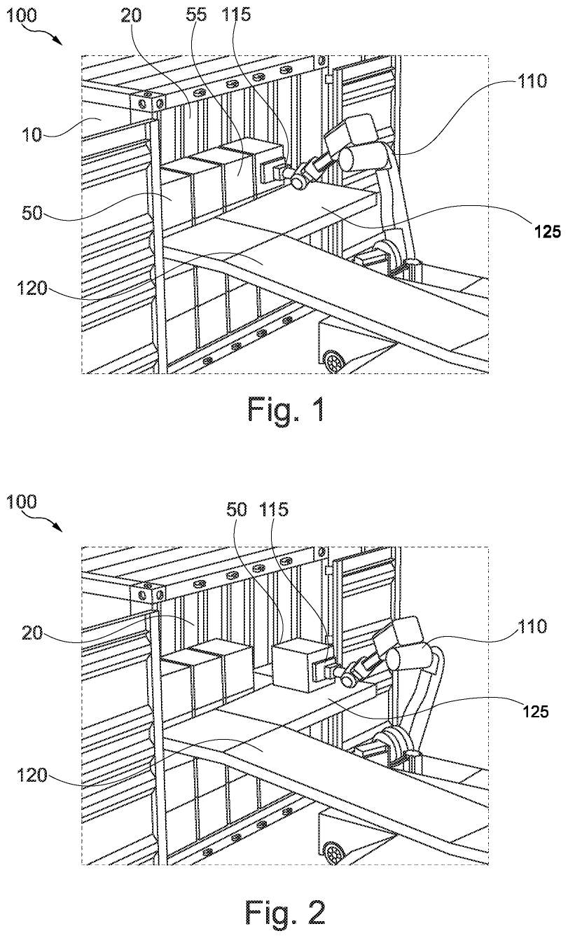

FIG. 1 shows schematically an example of an unloading system 100 for automatically unloading an object 50 from a container 20 of a truck 10. The robot arm 110 comprises a gripper 115 which may be a vacuum gripper that may comprise one or a plurality of suction elements. The suction elements may be designed to allow the gripper 115 grasping the object 50 on a side surface 55 and driving the object 50 to slide directly onto the loading surface 125.

The loading surface 125 may alternatively be a loading surface of a conveyor. Alternatively, a loading plate 120 that comprises the loading surface 125 may be provided in the unloading system 100. In this way, the unloading system 100 may comprise a set of the robot arm 110 and the loading plate 120.

The gripper 115 is arranged at the same side as the loading plate 120. Further, the loading plate 120 may be designed to be a movable loading plate, so that the loading plate 120 may be moved or arranged adjacent to or in the vicinity of the object 50 to be unloaded and the loading surface 125 may be arranged, based on a position of the object 50, for example at a same height or level as a bottom side of the object 50 for allowing the object 50 sliding laterally from a palletizing cell, on which a plurality of objects are piled and arranged, onto the loading surface. For example, the gripper 115 of the robot arm 110 may be designed to grasp the object 50 on the side for pulling the object 50 in a direction, for example, in a lateral direction.

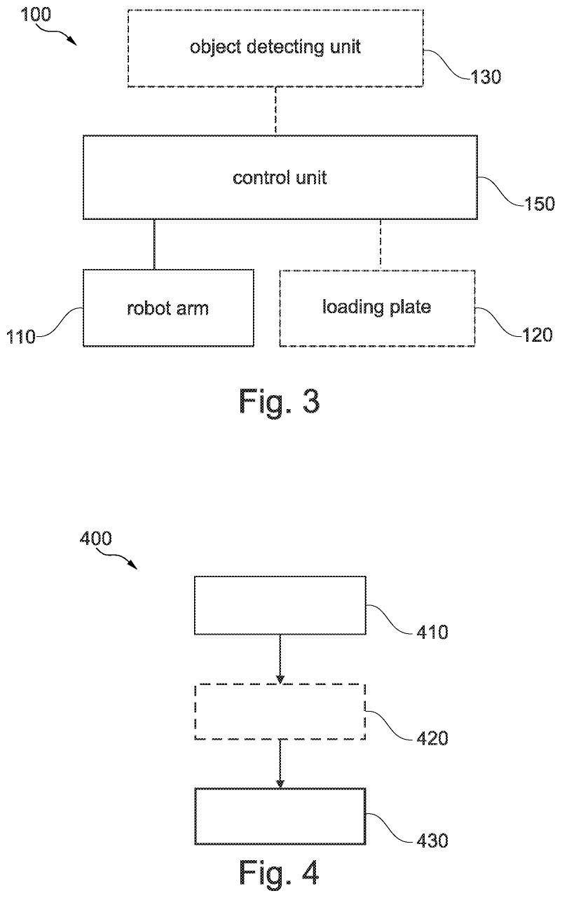

As shown in FIG. 3, the unloading system further comprises a control unit 150 (not visible in FIG. 1). The control unit 150 may be integrated in the robot arm 110 and/or separately in an external control system, for example in a computer center or a cloud system, to control the action or movement of the robot arm 110 and/or the gripper 115. Alternatively, the control unit 150 may be provided at least partially externally from the robot arm 110 to control both the robot arm 110 and the movable loading plate 120. In this case, the robot arm 110 may comprise an internal actuator, for example, to perform the movement of the gripper 115.

In FIG. 1, the control unit 150 may be configured to drive the robot arm 110 to place the gripper 115 at the side surface of the object, to grasp the object 50 on the side, and to allow the gripper prepared to exert the lateral force to the object 50 for unloading the object 50.

Further, FIG. 2 shows that the control unit 150 is configured to drive the object, by means of the gripper 115 of the robot arm 110, to slide onto the loading surface 125. In other words, the control unit 150 is configured to allow the gripper 115, for example by means of the suction elements provided at the gripper, pulling the object directly to slide onto the loading surface arranged at the same height level. Additionally, the control unit 150 may be configured to release the object 50 on the loading surface 125, by means of the gripper 115.

Following the above-described unloading mechanism, the gripper 115 may be configured to unload the object 50 without grasping on the top of the object 50 as a conventional gripper to lift the object 50 and then placing the object 50 on a conveyor. In this way, the gripper 50 may pull the object 50 to perform a translational movement in a lateral direction without changing the height level above the ground of the object 50.

FIG. 3 shows that the unloading system 100 may further comprise an object detecting unit 130. The object detecting unit 130 may be arranged or integrated in the robot arm 110. Alternatively, the object detecting unit 130 may be provided separately and configured to interact with the robot arm 110 and the control unit 150.

The object detecting unit 130 may be configured to detect the position of the object 50. Accordingly, the control unit 150 may be configured to move the loading plate 120, based on the detected position of the object 50, for arranging the loading surface 125 and for allowing the object 50 sliding onto the loading surface 125.

Alternatively, or additionally, the object detecting unit 130 may be configured to detect at least one characteristic of the object 50 for determining a region of the side surface 55 of the object 60 for the gripper to be placed. The at least one characteristic of the object 50 may comprise a size, a shape, a center of gravity, a type of material and/or a way of packaging the object 50. For example, the region of the side surface 55 of the object 50 may be a central region of the side surface 55 of the object 50.

The object 50 may be a cardboard, a bag or a crate. For example, by detecting and determining the size, the shape and/or the type of the material of the object 50 using the object-detecting unit 130, the control unit 120 and the robot arm 110 may be configured to allow the suction elements of the gripper 115 to firmly grasp the object 50 on the side surface 55.

FIG. 4 shows a flow chat illustrating an embodiment of a method 400 for automatically unloading an object 50 by means of an unloading system 100. In step 410, a robot arm 110 is driven by means of a control unit 150 and a gripper 115 of the robot arm 110 is placed at the object 50. For example, the gripper 115 may be arranged, by means of the robot arm 110, at a side surface 55 of the object 50, depending on the planned direction of the translational movement of the object 50. Alternatively, or additionally, the gripper 115 may be placed on a predefined region of the object 55 for the unloading, for example, on an edge of the object 55.

In step 430, the gripper 115 is allowed to exert a lateral force to the object 50 and the object 50 is driven to slide onto a loading surface 125. Optionally, in step 420, prior to the step 410 or after the step 410 and before the step 430, a loading plate 120 comprising the loading surface may be moved, by means of the control unit 150, and a position of the loading plate 120 may be adjusted based on a position of the object 50 for arranging the loading surface 125 and for allowing the object 50 sliding onto the loading surface 125, for example, in a lateral direction.

Optionally, prior to the step 410 of driving the robot arm 110 and placing the gripper 115 at the object 50, a further step may be provided, in which the position of the object 50 may be detected, by means of an object detecting unit 130, for the step of moving the loading plate for arranging the loading surface 125 and for allowing the object 50 sliding onto the loading surface 125.

Optionally, a further step may be provided in which at least one characteristic of the object 50 may be detected, by means of the object detecting unit 130, for determining a region, for example a middle or central region, of the side surface 55 of the object 50 for the gripper 115 to be placed. The at least one characteristic of the object 50 may comprise a size, a shape, a center of gravity, a type of material and/or a way of packaging the object 50.

For example, the gripper of the robot arm may be placed at a certain region of the object for exerting the lateral force and allowing the object sliding or being translationally moved. In particular, the control unit may be configured to arrange the gripper at a side surface of the object. The side surface of the object may alter and be flexible depending on the space conditions for the unloading process. Alternatively, or additionally, the gripper may be placed on a predefined region of the object for moving the object, for example, on an edge of the object.

The unloading system may be implemented for object by object unloading or item by item unloading. The object may be initially placed in an object cell comprising a plurality of objects in a container or in a truck. Alternatively, or additionally, the unloading system may also be used for unloading multiple or bulk objects, for example, when the multiple objects may be placed on the same level and/or the gripper may be designed to handle the multiple objects or sufficiently cover the multiple objects.

Compared to the lifting or carrying mechanism in the conventional unloading process for the item or object to be unloaded from the top of the object, the robot arm may, for example, drag or pull the object directly onto a loading surface of a loading plate or a conveyor.

Advantageously, the dragging or pulling mechanism of the unloading system may optimize an unloading capacity and eliminate kinematic issues that may appear when trying to lift the items. Most of the objects in a container or in a truck, for example as carton boxes, may not be developed to be lifted from the top. For example, the strength, the weight of the carton and/or its content and the thickness of the cartons may not be designed for lifting mechanism during the unloading process.

Moreover, manipulating the object from the top may create challenges with an inertia and a peel-off from the lower object. Instead, the use of the “drag-and-drop” approach may efficiently address the above-mentioned technical restrictions and increase the capacity to a manual performance level. For example, when carrying or lifting the object with a robotic gripper, the object inertia and the carton strength may need to be taken into account. When sliding the object or item directly onto the loading surface, this risk may be eliminated. As such, the cycle of the dragging-manipulating-releasing process using the unloading system may take less time than the cycle of the picking or lifting-manipulating-dropping process using the conventional unloading gripper, resulting an increased capacity.

According to an embodiment, the gripper of the robot arm may be a vacuum gripper, a magnetic gripper, a pneumatic gripper, an adhesive gripper, a gecko gripper, a mechanical gripper or a bio-inspired gripper.

The term the gripper may be understood broadly and may relate to a generic gripper that may be configured to exert a lateral force on the object for driving the object to perform a translational movement. It may be noted that the gripper may not be limited to the above listed gripper types, but a gripper of a different type.

According to another embodiment, the gripper may comprise at least one suction element. The at least one suction element may be configured to allow the gripper to grasp the object on a side surface and drive the object to slide directly onto the loading surface.

For example, the side surface may be the surface of a front side of the object facing the outside of the container or the truck.

The at least one suction element of the vacuum gripper may comprise one or a plurality of suction elements. These suction elements may be arranged at the surface of the gripper and designed to be activated selectively, so that the gripper may firmly grasp the object on the side for a translational movement. It may be provided that only part of the suction elements to be activated may be sufficient for a certain object.

According to another embodiment, the loading surface may be a loading surface of a conveyor, an open-ended loading surface or a loading surface of a loading plate.

Advantageously, the shape of the object may not be determined for the unloading system using the robot arm with the vacuum gripper to be placed on the side. Typically, the object, for example a carton box, may be designed to comprise a greater length than a width and a height of the front side. This may result in the carton box not being picked up from the side with vacuum. However, the vacuum may be sufficient if the gripper is designed to pick the carton box from the side by pulling or dragging the carton box to slide onto the loading surface.

Further, the weight of the object may not be a deciding factor for the unloading process using the unloading system of the present disclosure. As long as the object may be slidable on the conveyor or the loading plate, the unloading of the object may be realized.

According to another embodiment, the unloading system may comprise the loading plate that may comprise the loading surface. The control unit may be configured to allow the gripper pulling the object to slide onto the loading surface and/or releasing the object on the loading surface.

When pulling or dragging the object, the payload of the gripper and/or of the robot arm may not need to be as high as when carrying or lifting the object. This means that a smaller or more compact robot arm type may be used inside a container or a truck for unloading an object or a plurality of objects in the truck.

According to another embodiment, the loading plate may be a movable loading plate. Alternatively, the loading plate may be a stationary or fixed loading plate, which may, for example, be pre-arranged in the vicinity of the object to be unloaded.

In case the loading plate is designed to be movable, the control unit may be configured to move the loading plate and adjust a position of the loading plate, based on a position of the object, for arranging the loading surface and for allowing the object sliding onto the loading surface.

It may be provided that the conveyor or the loading plate, onto which the object may be dragged or pulled on, may be able to move up and down between the gripper of the robotic arm and the object, until that the loading surface is placed relative to the object to be unloaded for allowing a laterally translational movement or a sliding movement of the object without a lifting movement.

Accordingly, the control unit may be configured, so that the conveyor or the loading plate may be positioned precisely in the region or at the area where the robot arm is working, so that the object may not drop when being dragged or pulled.

According to another embodiment, the unloading system may further comprise an object detecting unit, which may be configured to detect the position of the object. The control unit may be configured to move the loading plate, based on the detected position of the object, for arranging the loading surface and for allowing the object sliding onto the loading surface.

According to another embodiment, the object detecting unit may be configured to detect at least one characteristic of the object for determining a region of the side surface of the object for the gripper to be placed. The at least one characteristic of the object may comprise, but not limited to, a size, a shape, a center of gravity, a type of material and/or a way of packaging the object.

For example, the object detection unit may be integrated into the robot arm or provided separately to detect or monitor the object. Moreover, the object detecting unit may be configured to evaluate or analyze the characteristics of the object while detecting the object.

According to another embodiment, the object may be a cardboard box, a bag or a crate. It may be noted that the characteristics of the object may not be limited to the above-listed parameters.

The sample unloading principle may be used for other object types, such as the cardboard box, the bag, a crate or a box made from a metal, a plastic or another material. According to another embodiment, the gripper may be arranged at the same side as the loading surface.

Additionally or alternatively, the gripper may be arranged at a different side from the loading surface, if the control unit may further be configured to allow the gripper pushing the object from the loading surface to a second loading surface, when the movable loading plate may be moved further by the control unit to align the loading surface with the second loading surface. For example, if the loading surface is provided at the loading plate of the unloading system and the second loading surface is arranged at a further conveyor, the object to be unloaded may be automatically transported to the next second loading surface of the further conveyor via the loading surface of the loading plate.

Since the movement of the robot arm may be limited due to the simple translational movement in a single lateral direction of the object while being unloaded, a higher throughput may be reached with the unloading system compared to the conventional lifting unloading system in which the gripper and/or the robot arm may need to be rotate, for example, about 180°.

According to a second aspect, a robot arm is provided for an unloading system that comprises a gripper. The gripper is configured to be placed at an object and to exert a lateral force to the object for driving the object to slide onto a loading surface.

According to a third aspect, a loading plate is provided for an unloading system that comprises a loading surface. The loading plate is configured to be movable by the control unit, by the means of the control unit, and a position of the loading plate is configured to be adjusted, based on a position of the object, for arranging the loading surface and for allowing the object sliding onto the loading surface.

According to a third aspect, the use of an unloading system is provided for automatically unloading an object from a container or a container of a truck.

Further, the use of the unloading system may be provided for a generic object cell, for example a palletizing cell, comprising a plurality of objects, among which one or multiple objects may be unloaded.

By dragging or pulling an object using the unloading system of the present disclosure instead of lifting the object using the conventional gripper, a more robust robotic gripping system may be provided that may handle a much larger variety of customized or individual objects in a faster or more efficient way. Also, some major downsides, for example regarding the item inertia, that may come with the object manipulation may be eliminated as well.

Additionally, the use of the robot arm may also be provided for further automation applications, for example, for object picking or packing, logistics, installation and/or system management. According to a fourth aspect, a method is provided for automatically unloading an object by means of an unloading system. The method comprises the following steps: driving, by means of a control unit, a robot arm and placing a gripper of the robot arm at an object; allowing the gripper exerting a lateral force to the object and driving the object to slide onto a loading surface.

According to an embodiment, the method may further comprise the step of moving, by means of the control unit, a loading plate comprising the loading surface and adjusting a position of the loading plate based on a position of the object for arranging the loading surface and for allowing the object sliding onto the loading surface.

According to another embodiment, the method may further comprise the step of detecting, by means of an object detecting unit, the position of the object for the moving of the loading plate for arranging the loading surface and for allowing the object sliding onto the loading surface.

According to another embodiment, the method may further comprise the step of detecting, by means of the object detecting unit, at least one characteristic of the object for determining a region of the side surface of the object for the gripper to be placed. The at least one characteristic of the object may comprise a size, a shape, a center of gravity, a type of material and/or a way of packaging of the object. For example, the region of the side surface of the object may be a central region of the side surface of the object.

According to another aspect, there is provided a computer program that comprises machine-readable instructions that, when executed by one or more computers and/or compute instances, cause the one or more computers and/or compute instances to perform a method for operating a robot arm for an automation system.

According to another aspect, there is provided a non-transitory machine-readable data carrier and/or a download product with the computer program. A download product is an instance of the computer program that may be sold and downloaded online for immediate fulfilment in lieu of physically shipping a machine-readable data carrier.

According to another aspect, there are provided one or more computers and/or compute instances with the computer program comprising machine-readable instructions that, when executed by one or more computers and/or compute instances, cause the one or more computers and/or compute instances to perform a method for operating a robot arm for an automation system, and/or with the machine-readable data carrier and/or download product with the computer program.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

10 truck
20 container
50 object
55 side surface
100 unloading system
110 robot arm
115 gripper
120 loading plate
125 loading surface
130 object detecting unit
150 control unit
400 method for automatically unloading an object
410 step of driving a robot arm and placing a gripper
420 step of moving a loading plate
430 step of allowing the gripper exerting a lateral force to the object

What is claimed is:

1. An unloading system for automatically unloading an object, comprising:
a robot arm comprising a gripper;
a control unit;
wherein the control unit is configured to drive the robot arm to place the gripper at the object; and
wherein the control unit is configured to allow the gripper exerting a lateral force to the object and driving the object to slide onto a loading surface.

2. The unloading system according to claim 1, the gripper of the robot arm is a vacuum gripper, a magnetic gripper, a pneumatic gripper, an adhesive gripper, a gecko gripper, a mechanical gripper or a bio-inspired gripper.

3. The unloading system according to claim 1, wherein the gripper comprises at least one suction element; wherein the at least one suction element is configured to allow the gripper grasping the object on a side surface and driving the object to slide directly onto the loading surface.

4. The unloading system according to claim 1, the loading surface is a loading surface of a conveyor, an open-ended loading surface or a loading surface of an loading plate.

5. The unloading system according to claim 1, wherein the loading plate comprises the loading surface; and wherein the control unit is configured to allow the gripper pulling the object to slide onto the loading surface and/or releasing the object on the loading surface.

6. The unloading system according to claim 5, wherein the gripper is arranged at the same side as the loading plate.

7. The unloading system according to claim 5, wherein the loading plate is a movable loading plate; and wherein the control unit is configured to move the loading plate and adjust a position of the loading plate, based on a position of the object, for arranging the loading surface and for allowing the object sliding onto the loading surface.

8. The unloading system according to claim 5, further comprising an object detecting unit; wherein the object detecting unit is configured to detect the position of the object; and wherein the control unit is configured to move the loading plate based on the detected position of the object for arranging the loading surface and for allowing the object sliding onto the loading surface.

9. The unloading system according to claim 8, wherein the object detecting unit is configured to detect at least one characteristic of the object for determining a region of the side surface of the object for the gripper to be placed; wherein the at least one characteristic of the object comprises a size, a shape, a center of gravity, a type of material and/or a way of packaging of the object.

10. The unloading system according to claim 9, wherein the object is a cardboard box, a bag or a crate.

11. The unloading system according to claim 1, further comprising a gripper configured to be placed at an object and to exert a lateral force to the object for driving the object to slide onto a loading surface.

12. The unloading system of claim 1, further comprising a loading plate having a loading surface; wherein the loading plate is configured to be movable by the control unit, and wherein a position of the loading plate is configured to be adjusted, based on a position of the object, for arranging the loading surface and for allowing the object sliding onto the loading surface.

13. A method for automatically unloading an object using an unloading system, comprising:
driving, a robot arm using a control unit, and placing a gripper of the robot arm adjacent the object;
placing a loading surface next to the object; and
using the gripper to exert a lateral force on the object and sliding the object onto a loading surface.

14. The method according to claim 13, further comprising moving, using the control unit, a loading plate that includes the loading surface, and adjusting a position of the loading plate based on a position of the object for arranging the loading surface and for allowing the object to slide onto the loading surface.

15. The method according to claim 14, further comprising detecting, using an object detecting unit, a position of the object for moving the loading plate into position for arranging the loading surface and for allowing the object to slide onto the loading surface.

16. The method according to claim 15, further comprising detecting, using the object detecting unit, at least one characteristic of the object for determining a region of a side surface of the object for the gripper to be placed; wherein the at least one characteristic of the object comprises a size, a shape, a center of gravity, a type of material and/or a way of packaging of the object.

17. A computer program comprising machine-readable instructions that, when executed by one or more computers and/or compute instances, cause the one or more computers and/or compute instances to perform a method for automatically unloading an object using an unloading system, the computer program comprising:
instructions for driving, a robot arm using a control unit, and placing a gripper of the robot arm adjacent the object;
instructions for placing a loading surface next to the object; and
instructions for using the gripper to exert a lateral force on the object and sliding the object onto a loading surface.
